(19) United States
(12) Patent Application Publication
(10) Pub. No.: US 2023/0202936 A1
(43) Pub. Date: Jun. 29, 2023

(54) COMPOSITE MATERIALS AND METHODS OF PREPARATION THEREOF

(71) Applicants: Edward F. CASSIDY, Corpus Christi, TX (US); Russell L. HILL, San Antonio, TX (US); Robert W. SHUGDINIS, Simsbury, CT (US); Xi ZHANG, Mechanicsburg, PA (US); Ying ZHANG, Wildwood, MO (US); WESTLAKE ROYAL BUILDING PRODUCTS INC., Houston, TX (US)

(72) Inventors: Edward F. CASSIDY, Corpus Christi, TX (US); Russell L. HILL, San Antonio, TX (US); Robert W. SHUGDINIS, Simsbury, CT (US); Xi ZHANG, Mechanicsburg, PA (US); Ying ZHANG, Wildwood, MO (US)

(73) Assignee: WESTLAKE ROYAL BUILDING PRODUCTS INC., Houston, TX (US)

(21) Appl. No.: 17/995,076

(22) PCT Filed: Mar. 18, 2021
(86) PCT No.: PCT/US2021/022906

§ 371 Date: Sep. 29, 2022

Related U.S. Application Data
(60) Provisional application No. 63/004,649, filed on Apr. 3, 2020.

(51) Int. Cl. C04B 38/00; C04B 41/00; C04B 41/45; C04B 41/48; C04B 41/83

(52) U.S. Cl. CPC C04B 38/0096; C04B 41/009; C04B 41/4539; C04B 41/4884; C04B 41/4838; C04B 41/83; E04C 2/24

(57) ABSTRACT

Composite materials that include a structural support are described, wherein the structural support defines a plurality of cavities at least partially filled with a polymeric foam. The polymeric foam may have a density less than 5 pcf and/or the composite material may have a compressive strength of at least 60 psi.

### CROSS-REFERENCE TO RELATED APPLICATION

This application claims priority to U.S. Provisional Application No. 63/004,649, filed Apr. 3, 2020, which is incorporated by reference herein in its entirety.

### TECHNICAL FIELD

The present disclosure generally relates to composite materials, and methods of use and preparation thereof.

### BACKGROUND

Polymeric structural composites are useful for various applications due to their physicochemical properties. Yet, such composites may add high levels of weight and/or density to building materials and structures.

### SUMMARY

The present disclosure includes composite materials and methods of preparing composite materials. For example, the present disclosure includes a composite material comprising a structural support having a plurality of cavities; and a polymeric foam filling the plurality of cavities; wherein the polymeric foam has a density less than 5 pcf; and wherein the composite material has a compressive strength of at least 60 psi. The composite material may have an average density of 1 pcf to 20 pcf or 3 pcf to 10 pcf.

According to some examples herein, the structural support may comprise a polymer, a fiber, a metal, or a combination thereof. In some examples, the structural support may comprise paper, cardboard, fiberglass, glass fiber, carbon fiber, aramide fiber, or a combination thereof. In other examples, the structural support may comprise polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, or a combination thereof. In at least one example, a composition of the structural support is the same as a composition of the polymeric material. In some examples herein, the polymeric foam may comprise polyurethane or polyvinylchloride. The polymeric foam may further comprise an inorganic filler present in an amount up to 60% by weight, relative to the total weight of the polymeric material.

In some examples herein, the structural support may have a thickness of about 0.25 mm to about 65 mm. In other examples, the composite material may have a generally rectangular shape with a thickness of about 0.25 inches to about 3 inches. In at least one example, the cavities of the structural support have a circular or polygonal shape.

The present disclosure also includes a composite material comprising a structural support having a plurality of cavities, the structural support comprising a first polymeric foam; and a second polymeric foam filling the plurality of cavities; wherein the composite material has an average density less than 20 pcf; and wherein the composite material has a compressive strength of at least 60 psi. In at least one example, the first polymeric foam has a different chemical composition than the second polymeric foam. The polymeric foam may have a density less than 5 pcf.

The present disclosure also includes methods of preparing composite materials. For example, the method may comprise preparing a structural support having a plurality of cavities, the structural support comprising a first polymeric material; and covering the structural support with a polymer mixture comprising a blowing agent, such that the polymer mixture foams to fill the cavities with a second polymeric material; wherein the composite material has an average density less than 15 pcf. In some examples, the first polymeric material may be foamed and may comprise polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, or a combination thereof. In at least one example, the polymer mixture may comprise an isocyanate, at least one polyol, and an inorganic filler. In some examples, the structural support may be prepared using pinch-roller thermoforming, thermoform stamping, a folding process, a shaping process, a bonding process, or a combination thereof. In at least one example, the structural support is covered with the polymer mixture in a closed mold.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIGS. 1A-1E show exemplary support structures, according to some aspects of the present disclosure.

FIG. 2 shows an exemplary support structure, polymeric foam, and composite material, according to some aspects of the present disclosure.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass±5% of a specified amount or value. All ranges are understood to include endpoints, e.g., a molecular weight between 250 g/mol and 1000 g/mol includes 250 g/mol, 1000 g/mol, and all values between.

The present disclosure generally includes composite materials comprising a structural support and methods of preparing such composite materials. For example, the composite materials herein may comprise a structural support having a plurality of cavities at least partially filled with a polymeric foam. The composite materials herein may have a relatively low density and a compressive strength sufficient for use in various building materials. The mechanical properties of the composite materials may allow for their use in place of other materials such as lumber, plywood, particle board, and other wood- or fiber-based materials.

The structural supports of the composite materials herein define a plurality of cavities. The cavities may be defined by one or more surfaces of the structural support. The term cavities includes, for example, voids in any form such as indentations in an upper surface, lower surface, and/or side surface of the structural support, as well as through-holes, apertures, or passages extending through the structural support.

The cavities of the structural support may have various shapes, such as a circular shape (circular cross-section) or polygonal shape (polygonal cross-section), e.g., rectangular, pentagonal, hexagonal, etc. For example, the structural support may have a three-dimensional (3D) shape such as a honeycomb structure (e.g., including one or more through-holes), a waffle-like structure (e.g., including one or more indentations), a corrugated structure, or a zigzag structure (e.g., including one or more indentations). Further, for example, the structural supports herein may have a polygonal shape (e.g., square, rectangular, triangular, rhomboidal, trapezoidal, cubic, etc.), a curved shape (e.g., oval, circular, etc.) or a combination thereof, wherein the structural support may define a plurality of cavities, such as one or more through-holes, indentations, or a combination thereof. In some examples, the structural support may have a repeating configuration forming a plurality of cavities of substantially the same shape and/or substantially the same volume. In at least one example, the structural support defines a plurality of cavities on an upper surface, a lower surface, or both an upper surface and a lower surface of the structural support. In at least one example, the structural support has a porous structure, e.g., defining one or more cavities in the form of apertures extending between an upper surface and a lower surface of the structural support.

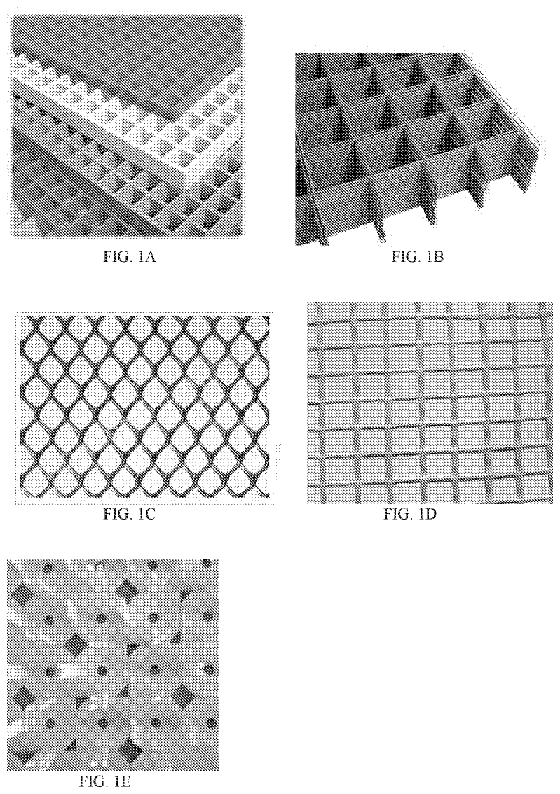

FIGS. 1A-1E show several examples of structural supports that may be used herein. FIG. 1A shows structural supports with a plurality of square-shaped cavities aligned in rows and columns, wherein the cavities are in the form of through-holes. In other examples, a structural support of the type depicted in FIG. 1A may define cavities in the upper surface and the lower surface of the structural support, similar to a waffle. In such cases, the structural support does not include through-holes. FIG. 1B shows an exemplary structural support with square-shaped cavities in the form of through-holes, wherein the structural support is formed from multiple support components stacked or otherwise coupled together. In this example, each support component has the same width and length, and the total thickness of the support structure is defined by the sum of the thickness of each support component. FIG. 1C shows an exemplary structural support with a plurality of rhomboidal cavities in the form of through-holes. The rhomboidal cavities are arranged in a regularly repeating pattern. FIG. 1D is similar to FIG. 1C but defines square-shaped cavities.

The types of support structures shown in FIGS. 1A-1D are generally symmetric with respect to x-, y-, and z-planes. FIG. 1E shows an exemplary support structure symmetric about x- and y-planes, but lacking symmetry about the z-plane. Additionally, the structural support in FIG. 1E defines cavities of different sizes and shapes (e.g., square, triangular, circular). The support structure includes a generally planar structure with projections, e.g., pillars, extending from the upper surface.

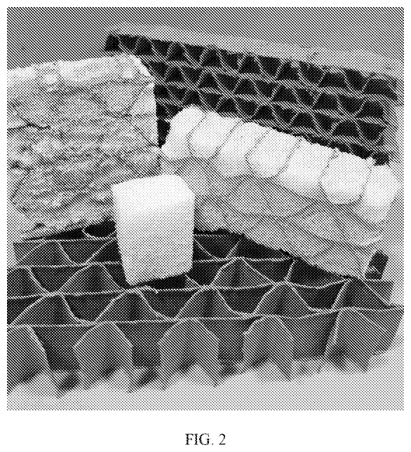

FIG. 2 shows another example of a support structure, as well as polymeric foam and a composite material comprising the support structure and polymeric foam. In FIG. 2, the exemplary support structure has a plurality of triangular cavities in the form of through-holes. The triangular cavities are arranged in a regularly repeating pattern.

In some examples of the present disclosure, the structural support, as a whole, has a thickness less than or equal to 65 mm, that is, the thickness of the material configured into the 3D shape is less than or equal to 65 mm. For example, the thickness may be about 0.25 mm to about 65 mm, for example 1 mm to 25 mm, 1 mm to 5 mm, 2 mm to 10 mm, 5 mm to 20 mm, 10 mm to 40 mm, 15 mm to 30 mm, 50 mm to 65 mm, 7 mm to 15 mm, 20 mm to 30 mm, 10 mm to 15 mm, or 40 mm to 55 mm. In some examples, the thickness of the structural support may be uniform or substantially uniform (e.g., varying less than 5%). Further, the structural support may have a zigzag or honeycomb-like structure, wherein the cavities of the structural support are formed by walls having the same or substantially the same thickness, wherein the thickness of the walls forming the cavities is different from the thickness of the structural support, as a whole. The thickness of the structural support and the thickness of the walls forming the cavities may be present in a ratio ranging from 1:1 to 100:1 (sheet thickness: cavity wall thickness). For example, the ratio of sheet thickness to wall thickness may be 1:1 to 50:1, 1:1 to 25:1, or 1:1 to 10:1. In at least one example, the thickness of the structural support is 20 mm to 50 mm, and the thickness of the walls forming the cavities is 0.5 mm to 5 mm. (i.e., a ratio of sheet thickness:cavity wall thickness of 4:1 to 100:1).

The structural support may comprise a single material or combination of materials. For example, the structural support may comprise one or more polymers (optionally in the form of a foam), fibers, metals, or a combination thereof. Exemplary materials suitable for the structural supports herein include, but are not limited to, paper, cardboard, fiberglass, glass fiber, carbon fiber, aramide fiber, polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, aluminum, and combinations thereof. The structural support may be pre-formed or formed in-situ with one or more polymeric materials. In some examples, the structural support comprises a polymer foam, including a filled polymer foam. The density of a structural support comprising a polymer foam may be less than or equal to 20 lb/ft³(pcf), such as 1 pcf to 20 pcf, 5 pcf to 10 pcf, or 1 pcf to 10 pcf. In some examples, the density of the structural support is less than or equal to 5 pcf or less than or equal to 2 pcf.

The composite materials herein include a polymeric material in the form of a foam at least partially filling the cavities of the structural support. While the following discussion refers to exemplary materials that may be used to prepare a polymeric foam for combination with the structural support, it is understood that the same materials may be used for the structural support, which may be foamed or unfoamed.

Exemplary polymers suitable for use in the polymeric foams include, but are not limited to, polyurethane, polyvinylchloride, polypropylene, polyethylene, polyethylene terephthalate, polyamide, polystyrene, acrylonitrile butadiene styrene, polycarbonate, polyethylenimine, or a combination thereof. For example, a polymeric foam may be prepared with a chemical or physical blowing agent. In some examples, the polymeric foam consists of or consists essentially of one or more polymers, e.g., polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, or a combination thereof. In some examples, the polymeric foam comprises a polymer and a filler, and optionally other components such as a fiber material.

In some examples, the polymeric foam comprises polyurethane, e.g., prepared by foaming a mixture comprising an isocyanate and a polyol or mixture of polyols. Isocyanates suitable for use in preparing the polymeric foams herein may include at least one monomeric or oligomeric poly- or di-isocyanate. The monomeric or oligomeric poly- or diisocyanates include aromatic diisocyanates and polyisocyanates. The particular isocyanate used in the mixture may be selected based on the desired viscosity of the mixture used to produce the polymeric material and/or composite materials. For example, a low viscosity may be desirable for ease of handling and transporting. Other factors that may influence the particular isocyanate can include the overall properties of the polymeric material and/or composite materials, such as the amount of foaming, strength of bonding to a functional filler, wetting of inorganic fillers in the mixture, strength of the resulting composite, stiffness (elastic modulus), and reactivity.

The polymeric material may comprise at least one polyol, which may be in liquid form. For example, liquid polyols having relatively low viscosities generally facilitate mixing. Suitable polyols include those having viscosities of 6000 cP or less at 25° C., such as a viscosity of 150 cP to 5000 cP, 250 cP to 4500 cP, 500 cP to 4000 cP, 750 cP to 3500 cP, 1000 cP to 3000 cP, or 1500 cP to 2500 cP at 25° C. Further, for example, the polyol(s) may have a viscosity of 5000 cP or less, 4000 cP or less, 3000 cP or less, 2000 cP or less, 1000 cP or less, or 500 cP or less at 25° C.

The polyol(s) useful for the polymeric materials herein may include compounds of different reactivity, e.g., having different numbers of primary and/or secondary hydroxyl groups. In some embodiments, the polyols may be capped with an alkylene oxide group, such as ethylene oxide, propylene oxide, butylene oxide, and combinations thereof, to provide the polyols with the desired reactivity. In some examples, the polyols can include a poly(propylene oxide) polyol including terminal secondary hydroxyl groups, the compounds being end-capped with ethylene oxide to provide primary hydroxyl groups.

The polyol(s) useful for the present disclosure may have a desired functionality. For example, the functionality of the polyol(s) may be 7.0 or less, e.g., 1.0 to 7.0, or 2.5 to 5.5. In some examples, the functionality of the polyol(s) may be 6.5 or less, 6.0 or less, 5.5 or less, 5.0 or less, 4.5 or less, 4.0 or less, 3.5 or less, 3.0 or less, 2.5 or less, and/or 1.0 or greater, 2.0 or greater, 2.5 or greater, 3.0 or greater, 3.5 or greater, 4.0 or greater, 4.5 or greater, or 5.0 or greater. The average functionality of the polyols useful for the shapeable composites herein may be 2.5 to 5.5, 3.0 to 5.5, 3.0 to 5.0, 3.0 to 4.5, 2.5 to 4.0, 2.5 to 3.5, or 3.0 to 4.0.

The polyol(s) useful for the polymeric material herein may have an average molecular weight of 250 g/mol or greater and/or 1500 g/mol or less. For example, the polyol(s) may have an average molecular weight of 300 g/mol or greater, 400 g/mol or greater, 500 g/mol or greater, 600 g/mol or greater, 700 g/mol or greater, 800 g/mol or greater, 900 g/mol or greater, 1000 g/mol or greater, 1100 g/mol or greater, 1200 g/mol or greater, 1300 g/mol or greater, or 1400 g/mol or greater, and/or 1500 g/mol or less, 1400 g/mol or less, 1300 g/mol or less, 1200 g/mol or less, 1100 g/mol or less, 1000 g/mol or less, 900 g/mol or less, 800 g/mol or less, 700 g/mol or less, 600 g/mol or less, 500 g/mol or less, 400 g/mol or less, or 300 g/mol or less. In some cases, the one or more polyols have an average molecular weight of 250 g/mol to 1000 g/mol, 500 g/mol to 1000 g/mol, or 750 g/mol to 1250 g/mol.

Polyols useful for the polymeric materials herein include, but are not limited to, aromatic polyols, polyester polyols, poly ether polyols, Mannich polyols, and combinations thereof. Exemplary aromatic polyols include, for example, aromatic polyester polyols, aromatic polyether polyols, and combinations thereof. Exemplary polyester and poly ether polyols useful in the present disclosure include, but are not limited to, glycerin-based polyols and derivatives thereof, polypropylene-based polyols and derivatives thereof, and poly ether polyols such as ethylene oxide, propylene oxide, butylene oxide, and combinations thereof that are initiated by a sucrose and/or amine group. Mannich polyols are the condensation product of a substituted or unsubstituted phenol, an alkanolamine, and formaldehyde. Examples of Mannich polyols that may be used include, but are not limited to, ethylene and propylene oxide-capped Mannich polyols.

The polymeric materials optionally may comprise one or more additional isocyanate-reactive monomers. When present, the additional isocyanate-reactive monomer(s) can be present in an amount of 30% or less, 25% or less, 20% or less, 15% or less, 10% or less, or 5% or less by weight, based on the weight of the one or more polyols. Exemplary isocyanate-reactive monomers include, for example, polyamines corresponding to the polyols described herein (e.g., a polyester polyol or a poly ether polyol), wherein the terminal hydroxyl groups are converted to amino groups, for example by amination or by reacting the hydroxyl groups with a diisocyanate and subsequently hydrolyzing the terminal isocyanate group to an amino group. For example, the polymeric mixture may comprise a poly ether polyamine, such as polyoxyalkylene diamine or polyoxyalkylene triamine.

In some embodiments, the mixture may comprise an alkoxylated polyamine (e.g., alkylene oxide-capped polyamines) derived from a polyamine and an alkylene oxide. Alkoxylated polyamines may be formed by reacting a suitable polyamine (e.g., monomeric, oligomeric, or polymeric polyamines) with a desired amount of an alkylene oxide. The polyamine may have a molecular weight less than 1000 g/mol, such as less than 800 g/mol, less than 750 g/mol, less than 500 g/mol, less than 250 g/mol, or less than 200 g/mol.

In some embodiments, the ratio of number of isocyanate groups to the total number of isocyanate reactive groups (e.g., hydroxyl groups, amine groups, and water) in the mixture is 0.5:1 to 1.5:1, which when multiplied by 100 produces an isocyanate index of 50 to 150. In some embodiments, the mixture may have an isocyanate index equal to or less than 140, equal to or less than 130, or equal to or less than 120. For example, with respect to a mixture used to prepare some polymers herein, the isocyanate index may be 80 to 140, 90 to 130, or 100 to 120. Further, for example, with respect to polyisocyanurate foams, the isocyanate index may be 180 to 380, such as 180 to 350 or 200 to 350.

The polymeric materials herein (e.g., polymeric foams) may be prepared with a catalyst, e.g., to facilitate curing and control curing times. Examples of suitable catalysts include, but are not limited to catalysts that comprise amine groups (including, e.g., tertiary amines such as 1,4-diazabicyclo[2.2.2]octane (DABCO), tetramethylbutanediamine, and diethanolamine) and catalysts that contain tin, mercury, or bismuth. The amount of catalyst in the mixture may be 0.01% to 2% based on the weight of the mixture used to prepare the polymer of the composite (e.g., the mixture comprising the isocyanate(s), the polyol(s), and other materials such as foaming agents, surfactants, chain-extenders, crosslinkers, coupling agents, UV stabilizers, fire retardants, antimicrobials, anti-oxidants, cell openers, and/or pigments). For example, the amount of catalyst may be 0.05% to 0.5% by weight, or 0.1% to 0.25% by weight, based on the weight of the mixture used to prepare the polymeric material. In some embodiments, the mixture may comprise between 0.05 and 0.5 parts per hundred parts of polyol.

The polymeric materials herein may comprise a filler material, such as an inorganic material. Examples of fillers useful for the polymeric material herein include, but are not limited to, fly ash, bottom ash, amorphous carbon (e.g., carbon black), silica (e.g., silica sand, silica fume, quartz), glass (e.g., ground/recycled glass such as window or bottle glass, milled glass, glass spheres and microspheres, glass flakes), calcium, calcium carbonate, calcium oxide, calcium hydroxide, aluminum, aluminum trihydrate, clay (e.g., kaolin, red mud clay, bentonite), mica, talc, wollastonite, alumina, feldspar, gypsum (calcium sulfate dehydrate), garnet, saponite, beidellite, granite, slag, antimony trioxide, barium sulfate, magnesium, magnesium oxide, magnesium hydroxide, aluminum hydroxide, gibbsite, titanium dioxide, zinc carbonate, zinc oxide, molecular sieves, perlite (including expanded perlite), diatomite, vermiculite, pyrophillite, expanded shale, volcanic tuff, pumice, hollow ceramic spheres, hollow plastic spheres, expanded plastic beads, ground tire rubber, cenospheres, or mixtures thereof.

In some embodiments, the filler may comprise an ash produced by firing fuels including coal, industrial gases, petroleum coke, petroleum products, municipal solid waste, paper sludge, wood, sawdust, refuse derived fuels, switchgrass, or other biomass material. For example, the filler may comprise a coal ash, such as fly ash, bottom ash, or combinations thereof. Fly ash is generally produced from the combustion of pulverized coal in electrical power generating plants. In some examples herein, the composite comprises fly ash selected from Class C fly ash, Class F fly ash, or a mixture thereof. In some embodiments, the functional filler consists of or consists essentially of fly ash.

The filler may have an average particle size greater than or equal to 5 μm and/or less than or equal to 800 μm. For example, at least a portion of the filler may have an average particle size of 100 μm to 700 μm, 200 μm to 600 μm, or 300 μm to 500 μm. Further, for example, the filler may have an average particle size of 5 μm to 100 μm, such as 10 μm to 50 μm or 20 μm to 40 μm. In some embodiments, the filler has an average particle size diameter of 100 μm or more, 150 μm or more, or 500 μm or more, e.g., between 100 μm and 450 μm or between 500 μm and 800 μm. In some embodiments, the filler has an average particle size of 500 μm or less, 400 μm or less, or 350 μm or less, e.g., between 50 μm and 450 μm or between 200 μm and 350 μm.

The filler can be present in the polymeric material in an amount up to 60% by weight, relative to the total weight of the polymeric material, such as up to 10% by weight, up to 15% by weight, up to 20% by weight, up to 25% by weight, up to 30% by weight, up to 35% by weight, up to 40% by weight, up to 45% by weight, up to 50% by weight, or up to 55% by weight. In some examples, the polymeric foam comprises 1% to 60% by weight of a filler, such as 1% to 5% by weight, 5% to 10% by weight, 10% to 15% by weight, 10% to 30% by weight, 20% to 50% by weight, or 40% to 50% by weight. In some examples, the polymeric foam comprises greater than zero and less than 10% by weight, less than 5% by weight, or less than 1% by weight of a filler material.

In some examples, the polymeric material comprises one or more fiber materials. The fiber materials can be any natural or synthetic fiber, based on inorganic or organic materials. Exemplary fiber materials include, but are not limited to, glass fibers, silica fibers, carbon fibers, metal fibers, mineral fibers, organic polymer fibers, cellulose fibers, biomass fibers, and combinations thereof.

The polymeric materials herein may comprise at least one additional material, such as, e.g., foaming agents, surfactants, chain-extenders, crosslinkers, coupling agents, UV stabilizers, fire retardants, antimicrobials, anti-oxidants, cell openers, and/or pigments. The polymeric materials may be prepared as a foam using chemical blowing agents, physical blowing agents, or a combination thereof. If a blowing agent is present in the polymeric material, the amount of blowing agent may be present in an amount of less than 1 part per hundred, relative to the total weight of the polymeric material.

According to some aspects of the present disclosure, the density of the polymeric foam is less than or equal to 5 pcf, such as 1 pcf to 5 pcf, 2 pcf to 5 pcf, 3 pcf to 5 pcf, or 1 pcf to 3 pcf. In some examples, the density of the polymeric foam is less than or equal to 2 pcf or less than or equal to 1 pcf.

As mentioned above, the structural support may comprise a polymer, fiber, metal, or combination thereof. In some embodiments of the present disclosure, the structural support comprises a polymer, and the composition of the structural support is the same or different than the composition of the polymeric foam. For example, both the structural support and the polymeric foam may comprise polyurethane, polyvinylchloride, polypropylene, polyethylene, polyethylene terephthalate, polyamide, polystyrene, acrylonitrile butadiene styrene, polycarbonate, polyethylenimine, or a combination thereof, optionally with other components such as a filler material. In some examples, the structural support comprises a polymer different from the polymer of the polymeric foam. For example, the structural support defining a plurality of cavities may comprise a first polymeric material (optionally in the form of a foam), and the cavities of the structural support may be at least partially filled with a second polymeric material in the form of a foam. In at least one example, the polymeric foam comprises polyurethane, and the structural support comprises a polymer other than polyurethane.

The structural support and polymeric foam are present in the composite material in relative amounts such as that the composite material has an optimal density and compressive strength. The structural support and polymeric foam may be present in a weight ratio of 1:20 to 20:1 (structural support: polymeric foam), such as 1:10 to 10:1, 1:5 to 5:1, 1:2 to 2:1, or a ratio of 1:1.

Polymeric foams according to the present disclosure may be prepared using chemical blowing agents, physical blowing agents, or a combination thereof. The composite materials herein or a portion thereof may be prepared by free rise foaming or by extrusion.

In the case of free rise foaming, a polymer mixture is typically added to a mold and set aside to allow the mixture to foam. The resulting composite materials can then be cut into a desired shape and/or size, such as sheets or large blocks generally referred to as buns or foam buns. In some embodiments, the foaming may be in a mold or in situ. For instance, the foaming may occur adjacent to a mold surface or a building surface, such that a portion of the foam cell structure contacting such surface compresses or collapses. A portion of the foam cell structure compressed or collapsed may form a skin structure. In the case of extrusion, the mixture may be passed through a vessel of a continuous conveyer system, wherein the mixture foams and is shaped through contact with the walls of the vessel. In both cases, formation of the composite materials may be characterized in terms of the cream time, referring to the time at which the mixture starts to foam or expand, and the tack free time, referring to the period from the start of cure/foaming to a point when the material is sufficiently robust to resist damage by touch or settling dirt.

In an example according to the present disclosure, a pre-formed structural support having a plurality of cavities is combined with a polymer mixture comprising a blowing agent, such that the polymer mixture foams to partially or completely fill the cavities. For example, the structural support may be placed in a mold, optionally using one or more spacers to provide space between the structural support and the mold surface. The polymer mixture then may be added to the mold and allowed to foam and fill the spaces between the structural support and the mold. Alternatively, the polymer mixture may be added to the mold and the structural support may then be added while the polymer mixture forms a foam to fill the cavities of the structural support.

In some embodiments, the structural support may be formed in situ. For example, the structural support may comprise a polymeric material, e.g., polyurethane, polyvinylchloride, polypropylene, polyethylene, polyethylene terephthalate, polyamide, polystyrene, acrylonitrile butadiene styrene, polycarbonate, polyethylenimine, or a combination thereof. The polymeric material may be foamed, e.g., with the use of a blowing agent, into a desired 3D shape or into an initial form that then may be manipulated into the desired 3D shape. For example, the structural support may be prepared using pinch-roller thermoforming, thermoform stamping, a folding process, a shaping process, a bonding process, a laminating process, or a combination thereof. The bonding process may be a continuous or discontinuous skin bonding process, wherein a skin forms integrally with the structural support. Additionally or alternatively, a skin or coating may be applied to one or more surfaces of the structural support. In some examples, the coating may comprise a polymeric material, e.g., polyurethane, polyvinylchloride, polypropylene, polyethylene, polyethylene terephthalate, polyamide, polystyrene, acrylonitrile butadiene styrene, polycarbonate, polyethylenimine, or a combination thereof.

A polymer mixture comprising a blowing agent then may be added to the structural support (or vice-versa), such that the polymer mixture foams to fill the cavities of the structural support. In a least one example, the polymer mixture comprises an isocyanate, a polyol, and an inorganic filler to form a polyurethane foam. In at least one example, the polymer mixture comprises polyvinylchloride (e.g., heated to melt the polymer and combined with a suitable blowing agent for foaming) to form a polyvinylchloride foam.

In some examples, the structural support and the polymer mixture may be combined in a closed mold. The composite material may be prepared with any desired dimensions. For example, the composite material may be prepared in a mold of suitable dimensions and/or the composite material may be cut to the desired length, width, and thickness (depth). The composite material may have a length ranging from 1 inch to 8 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet. The composite material may have a width ranging from 1 inch to 8 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet.

The composite material may have a thickness (depth) ranging from 0.25 inches to 3 inches, 0.50 inches to 2.75 inches, 0.75 inches to 2.50 inches, or from 1 inch to 2.25 inches. As mentioned above, spacers of suitable thickness may be used to provide the desired depth of the composite material. The spacers may have a thickness of, for example, 0.25 inches, 0.50 inches, or 0.75 inches, to produce composite materials with a thickness of, for example, 0.75 inches, 0.50 inches, or 0.25 inches, respectively. In some examples, the thickness of the composite material may correspond to the thickness of the structural support.

In a non-limiting example, the composite material is about 6 inches in width, about 6 inches in length, and about 1.25 inches in thickness.

The structural support may have a desired length, width, and thickness. The structural support may have a length ranging from 1 inch to 3 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet. The structural support may have a width ranging from 1 inch to 3 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet. The structural support may have a thickness (depth) ranging from 0.25 mm to 65 mm, for example, from 0.25 mm to 60 mm, 0.25 mm to 50 mm, 0.25 mm to 40 mm, 0.25 mm to 30 mm, 0.25 mm to 20 mm, 0.50 mm to 10 mm, 0.50 mm to 20 mm, 0.50 mm to 30 mm, 0.50 mm to 40 mm, 0.50 mm to 50 mm, or 0.50 mm to 60 mm.

In some examples, a polymeric material may be poured into a mold to fill the cavities of the structural support, e.g., covering the upper surface, lower surface, and side surfaces of the structural support. The mold then may be closed and optionally heated, for example, at a temperature of about 60° C. After heating for approximately 2 hours, the mold is removed from the oven and the composite material is demolded. The composite material may include a skin or coating integrally formed on one or more surfaces of the composite material and/or a coating may be applied to one or more surfaces of the composite material after filling the cavities of the structural support with the polymeric foam.

As mentioned above, an exemplary composite material is shown in FIG. 2 alongside an unfilled support structure (before addition of polymeric foam) and a sample of polymeric foam for comparison. In the composite material, the polymeric foam fills the triangular cavities of the support structure to form a generally rectangular or square material. Optionally, the composite material may be cut to a desired shape and/or size.

The composite materials have a low or relatively low density. For example, the composite materials may have an average density of 20 pcf or less, such as 1 pcf to 20 pcf, e.g., 2 pcf to 15 pcf, 2 pcf to 10 pcf, 3 pcf to 10 pcf, 2 pcf to 6 pcf, or 3 pcf to 6 pcf (1 pcf=16.0 kg/m³). In some examples, the composite materials may have an average density greater than or equal to 2 pcf, greater than or equal to 4 pcf, greater than or equal to 6 pcf, and/or less than or equal to 20 pcf, less than or equal to 15 pcf, or less than or equal to 10 pcf.

The composite materials herein may have a compressive strength greater than or equal to 20 psi (145.0 psi=1 MPa), greater than or equal to 30 psi, greater than or equal to 40 psi, greater than or equal to 50 psi, greater than or equal to 60 psi, greater than or equal to 70 psi, greater than or equal to 80 psi, or equal than or equal to 90 psi, e.g., 20 psi to 200 psi, 50 psi to 150 psi, 50 psi to 100 psi, 120 psi to 150 psi, or 75 psi to 125 psi. Compressive strength can be measured by the stress measured at the point of permanent yield, zero slope, on the stress-strain curve as measured according to ASTM D695-15.

Additionally or alternatively, the composite materials may have a flexural strength greater than or equal to 5 psi, greater than or equal to 10 psi, greater than or equal to 50 psi, greater than or equal to 100 psi, greater than or equal to 200 psi, greater than or equal to 300 psi, greater than or equal to 400 psi, and/or less than or equal to 500 psi, less than or equal to 400 psi, less than or equal to 300 psi, less than or equal to 200 psi, or less than or equal to 100 psi. Flexural strength can be measured as the load required to fracture a rectangular prism loaded in the three point bend test as described in ASTM C1185-08 (2012), wherein flexural modulus is the slope of the stress/strain curve.

The composite materials may have a modulus of elasticity (stiffness) greater than or equal to 10 psi, greater than or equal to 100 psi, greater than or equal to 200 psi, greater than or equal to 300 psi, greater than or equal to 400 psi, greater than or equal to 500 psi, or greater than or equal to 600 psi, greater than or equal to 700 psi, greater than or equal to 800 psi, greater than or equal to 900 psi, or greater than or equal to 1000 psi. The modulus of elasticity can be from 10 psi to 1000 psi, 100 psi to 1000 psi, 200 psi to 1000 psi, 300 psi to 1000 psi, 400 psi to 1000 psi, or 500 psi to 1000 psi. The modulus of elasticity can be determined as described in ASTM C947-03.

The composite materials may have high anisotropic strength. Anisotropic strength refers to the compressive strength of the composite materials in different directions, e.g., along the thickness, along the length, and/or along the width. The composite materials herein may have an anisotropic strength ratio of at least 3:1, in the direction of thickness to length or thickness to width, e.g., greater than or equal to 5:1, or greater than or equal to 10:1. For example, the composite materials may have an anisotropic strength ratio of 3:1 to 50:1, 5:1 to 30:1, or 10:1 to 20:1.

The composite materials herein may combine low density with desired compressive strength, such that the composite may be suitable for use in building products. For example, the composite materials herein may have compressive strength and/or other mechanical properties comparable to materials such as plywood, particle board, and other wood- or fiber-based materials.

The composite materials herein may be used for any desirable type of building product. For example, the composite materials may be used in place of other materials such as lumber, structural sheet products, plywood, panels, backer boards, etc.

The composite materials herein can be prepared with any desired dimensions or shapes. According to some aspects of the present disclosure, the composite may be prepared as a flat sheet (e.g., in rectangular shape having a length, a width, and a thickness, as detailed above). A person of ordinary skill in the art will recognize that the composite materials need not be prepared in sheet-like form and other dimensions and shapes than those provided above are encompassed herein.

While principles of the present disclosure are described herein with reference to illustrative aspects for particular applications, the disclosure is not limited thereto. Those having ordinary skill in the art and access to the teachings provided herein will recognize additional modifications, applications, aspects, and substitution of equivalents that all fall in the scope of the aspects described herein. Accordingly, the present disclosure is not to be considered as limited by the foregoing description.

### EXAMPLES

The following examples are intended to illustrate the present disclosure without being limiting in nature. It is understood that the present disclosure encompasses additional embodiments consistent with the foregoing description and following examples.

### Example 1

The following composite materials are prepared according to amounts and methods of the present disclosure. First, the components are mixed to form a polymeric material. Second the polymeric material is combined with a structural support and allowed to free rise, wherein the structural support is a honeycomb structure. The structural support, without the polymeric material, had a compressive strength of 18 psi. The liquid blowing agent used was a low boiling point hydrocarbon.

TABLE 1

| | | Liquid | | | Presence of | | |
|---|---|---|---|---|---|---|---|
| | | Blowing | | Closed | Structural | | Compressive |
| | Water | Agent | Fly Ash | mold/ | Support | Density | Strength |
| Examples | (pphp) | (pphp) | (% wt.) | Free rise | (Y/N) | (pcf) | (psi) |
| Composite 1 | 8 | 20 | 0 | Free rise | Y | 2.9 | 61.3 |
| Composite 2 | 6 | 0 | 0 | Free rise | Y | 3.5 | 66.0 |
| Composite 3 | 6 | 20 | 0 | Free rise | N | 3.5 | 32.0 |

The results show that the combination of a structural support and polymeric material comprising at least one polyol and at least one filler successfully produced composite materials with a low or relatively low density, and high compressive strength.

It is intended that the specification and examples be considered as exemplary only, with a true scope and spirit of the present disclosure being indicated by the following claims.

What is claimed is:

1. A composite material comprising:
a structural support having a plurality of cavities; and
a polymeric foam filling the plurality of cavities;
wherein the polymeric foam has a density less than 5 pcf; and
wherein the composite material has a compressive strength of at least 60 psi.

2. The composite material of claim 1, wherein the composite material has an average density of 1 pcf to 20 pcf.

3. The composite material of claim 1, wherein the composite material has an average density of 3 pcf to 10 pcf.

4. The composite material of claim 1, wherein the structural support comprises a polymer, a fiber, a metal, or a combination thereof.

5. The composite material of claim 1, wherein the structural support comprises paper, cardboard, fiberglass, glass fiber, carbon fiber, aramide fiber, or a combination thereof.

6. The composite material of claim 1, wherein the structural support comprises polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, or a combination thereof.

7. The composite material of claim 1, wherein a composition of the structural support is the same as a composition of the polymeric material.

8. The composite material of claim 1, wherein the polymeric foam comprises polyurethane or polyvinylchloride.

9. The composite material of claim 1, wherein the polymeric foam comprises an inorganic filler present in an amount up to 60% by weight, relative to the total weight of the polymeric material.

10. The composite material of claim 1, wherein the structural support has a thickness of about 0.25 mm to about 65 mm.

11. The composite material of claim 1, wherein the composite material has a generally rectangular shape with a thickness of about 0.25 inches to about 3 inches.

12. The composite material of claim 1, wherein the cavities of the structural support have a circular or polygonal shape.

13. A composite material comprising:
a structural support having a plurality of cavities, the structural support comprising a first polymeric foam; and
a second polymeric foam filling the plurality of cavities;
wherein the composite material has an average density less than 20 pcf; and
wherein the composite material has a compressive strength of at least 60 psi.

14. The composite material of claim 13, wherein the first polymeric foam has a different chemical composition than the second polymeric foam.

15. The composite material of claim 13, wherein the polymeric foam has a density less than 5 pcf.

16. A method of preparing a composite material, the method comprising:
preparing a structural support having a plurality of cavities, the structural support comprising a first polymeric material; and
covering the structural support with a polymer mixture comprising a blowing agent, such that the polymer mixture foams to fill the cavities with a second polymeric material;
wherein the composite material has an average density less than 15 pcf.

17. The method of claim 16, wherein the first polymeric material is foamed, and wherein the first polymeric material comprises polyurethane, polyvinylchloride, polyvinylchloride copolymers, polypropylene, polyethylene, chlorinated polyethylene, chlorinated polypropylene, fluorinated polyethylene, fluorinated polypropylene, polyvinylidene chloride, polyvinyl alcohol, polyethylene terephthalate, polytetrafluorethylene, polyamide, polyimide, polystyrene, acrylonitrile butadiene styrene, polycarbonate, polyethylenimine, or a combination thereof.

18. The method of claim 16, wherein the polymer mixture comprises an isocyanate, at least one polyol, and an inorganic filler.

19. The method of claim 16, wherein the structural support is prepared using pinch-roller thermoforming, thermoform stamping, a folding process, a shaping process, a bonding process, or a combination thereof.

20. The method of claim 16, wherein the structural support is covered with the polymer mixture in a closed mold.
